(19) United States
(12) Patent Application Publication
(10) Pub. No.: US 2025/0323429 A1
(43) Pub. Date: Oct. 16, 2025

(54) CONNECTION ARRANGEMENT, IN PARTICULAR FOR USE IN ELECTRIC VEHICLES OR HYBRID VEHICLES

(71) Applicant: Robert Bosch GmbH, Stuttgart (DE)

(72) Inventor: Martin Luz, Tuebingen (DE)

(21) Appl. No.: 18/866,334

(22) PCT Filed: May 25, 2023
(86) PCT No.: PCT/EP2023/064111

§ 371 Date: Nov. 15, 2024

(30) Foreign Application Priority Data
Jun. 8, 2022 (DE) 10 2022 205 821.6

(51) Int. Cl. H01R 4/30; B60R 16/02; H01R 4/34; H01R 43/26

(52) U.S. Cl. CPC H01R 4/304; B60R 16/02; H01R 4/34; H01R 43/26; H01R 2201/26

(57) ABSTRACT

The invention relates to a connection arrangement (1), in particular for use in electric vehicles or hybrid vehicles, said connection arrangement comprising: a first planar terminal contact (11) having a planar first contact surface (15) for electrically contacting a first electrical and/or electronic component; and a second planar terminal contact (21) having a second contact surface (25) for electrically contacting a second electrical and/or electronic component, wherein the first planar terminal contact (11) and the second planar terminal contact (21) overlap in an overlap region (5), wherein the first contact surface (15) faces the second contact surface (25), wherein the first planar terminal contact (11) and the second planar terminal contact (21) are connected by means of a connecting element (30), and the first contact surface (15) is pressed against the second contact surface (25) by the connecting element (30). According to the invention, a structure (17) is embossed in the first planar terminal contact (11) so that an edge (16) of the first planar terminal contact (11) projects out of the plane of the first contact surface (15), wherein the edge (16) projecting from the plane of the first contact surface (15) is pressed into the second contact surface (25) of the second planar terminal contact (21) by the connecting element (30).

### BACKGROUND

The invention relates to a connection arrangement, in particular for use in electric vehicles or hybrid vehicles having the features of the disclosure.

In power electronics, for example in electric vehicles or hybrid vehicles, electrical and/or electronic components carrying high electric currents are connected to one another. Due to the high electric currents, current-conducting elements, via which the electrical and/or electronic components are connected, must have correspondingly low electric resistances and thus large cross-sections and or materials with high electric conductive properties. In such arrangements power is, e.g., supplied via power buses, which are also called busbars, and the electrical and/or electronic components are connected to one another via power buses.

To connect electrical and/or electronic components to one another, planar terminal contacts, for example power buses which form electric connections of the electrical and/or electronic components are electrically connected to one another. The planar terminal contacts overlap and are connected to one another, for example screwed, in the region where they overlap. When high currents flow over the connection, the maintenance of a low electric material resistance and the maintenance a low electric contact resistance is essential for minimizing the electric total conduction loss.

### SUMMARY

Proposed according to the invention is a connection arrangement, in particular for use in electric vehicles or hybrid vehicles. 1. The connection arrangement comprises a first planar terminal contact having a first planar terminal contact for electrically contacting a first electrical and/or electronic component, and a second planar terminal contact having a second contact surface for electrically contacting a second electrical and/or electronic component, the first planar terminal contact and the second planar terminal contact overlapping in an overlap region, the first contact surface facing the second contact surface, the first planar terminal contact and the second planar terminal contact being connected by means of a connecting element, and the first contact surface being pressed against the second contact surface by the connecting element. According to the invention, a structure is embossed into the first planar terminal contact so that an edge of the first planar terminal contact projects out of the plane of the first contact surface, whereby the edge projecting from the plane of the first contact surface is pressed into the second contact surface of the second planar terminal contact by the connecting element.

Compared to the prior art, the connection arrangement having the features of the disclosure has the advantage that an advantageously low electrical contact resistance is achieved in the connection between the two planar terminal contacts. This advantageously prevents an otherwise high heat generation and a high voltage drop at the contact point between the two planar terminal contacts. The edge of the first planar terminal contact, which is pressed into the second contact surface of the second planar terminal contact, causes the edge to be pressed through foreign layers on the second contact surface when the planar terminal contacts are mechanically fixed to each other, for example when they are screwed together. For example, the foreign layer can be an oxide layer caused by corrosion of the second planar terminal contact, which would result in a high contact resistance at the contact point between the two planar terminal contacts. The edge penetrates the foreign layer on the second contact surface when fixing the planar terminal contacts to each other. During the fixing of the planar terminal contacts to each other, for example when tightening a screw connection, the embossed structure is pressed in a planar manner. A relative movement of the edge on the second contact surface occurs in this case, with the edge being pushed over the second contact surface. This relative movement breaks up the foreign layer on the second contact surface from the edge and, at the same time, removes the foreign layer on the edge. The relative movement thus breaks up the foreign layers which can, e.g., be oxide layers on the two planar terminal contacts. By fixing the planar terminal contacts, for example when tightening the screw connection, it is ensured that areas with an opened foreign layer then lie on top of each other and that no more foreign layer can form in this area where the areas lie on top of each other. An advantageously low and stable electrical resistance is thus achieved between the two terminal contacts. At the beginning of the screwing process, a line contact exists between the first planar terminal contact and the second planar terminal contact. The surface pressure is advantageously high in the area of the line contact during the screwing process because the pressed surface is very small (surface pressure=force/surface area). The external layer can thus be broken up very well due to the locally very high force.

According to one advantageous exemplary embodiment, it is provided that a first recess is formed in the first terminal contact in the overlap region, whereby the edge is formed by the side of the first terminal contact around the first recess, whereby the connecting element extends through the first recess in the first planar terminal contact. The edge around the connecting element is thus used to make the connection having the lower contact resistance. The recess, for example a hole for receiving a screw, is simultaneously used to make the connection to the side around this recess as an edge with advantageously low contact resistance. The edge extending around the recess for the connecting element can advantageously be pressed circumferentially into the second contact surface and produce an advantageously low electrical transition resistance between the two planar connecting elements. For example, a head, such as a screw head of the connecting element, can press the edge into the second contact surface of the second planar connecting element in a circumferential manner, for example annularly, when the connecting element is tightened. Due to the annular contact around the first recess, it is also possible to make a connection with advantageously low electrical resistance using small screws.

According to one advantageous exemplary embodiment, it is provided that a funnel-shaped structure is formed in the first terminal contact around the first recess. Such a structure is advantageously easy to manufacture and is particularly suitable for fixing the planar connecting elements to each other, for example, when fixing the connecting element, designed as a screw for example, to cause good relative movement of the edge on the second contact surface. During tightening, the funnel-shaped structure is pressed flat, and the edge breaks up the foreign layers in a radial direction.

According to one advantageous embodiment, it is provided that the connecting element is designed as a screw connection, and the first planar terminal contact and the second planar terminal contact are connected to each other and pressed together by means of the screw connection. The screw connection provides a particularly simple and, at the same time, advantageous mechanical connection between the planar terminal contacts. Furthermore, by tightening the screw, a force can be applied to the planar terminal contacts that presses the edge rigidly into the second contact surface and sufficient force can be applied to flatten the structure and break up the foreign layer on the second contact surface and the edge. A screw head can, for example, press around the first recess on the, for example, funnel-shaped structure and thus press the edge all around the first recess into the second contact surface. The edge is pushed radially away from the connecting element over the second contact surface and thus breaks up the foreign layer on the second contact surface in an annular manner.

According to one advantageous exemplary embodiment, it is provided that a second recess is formed in the second planar terminal contact, through which the connecting element projects, whereby the edge is pressed circumferentially into the second contact surface around the first recess, in particular in an annular manner. The connecting element can thus be arranged through both recesses, and the two planar terminal contacts can be easily connected to each other.

According to one advantageous exemplary embodiment, it is provided that the first planar terminal contact is designed as a power bus, and/or the second planar terminal contact is designed as a power bus. The power buses can be connected to each other particularly well in the manner described. In particular, the power buses can be advantageously simple and cheaply punched and embossed. The first recess in a power bus can advantageously be simply manufactured by punching. A punched recess then comprises, e.g., a particularly sharp edge which can advantageously well penetrate the foreign layer on the second contact surface. The embossed structure can be made particularly easily on a first planar terminal contact designed as a power bus.

Further proposed is a method for manufacturing a connection arrangement. The method comprises a step for providing a first planar terminal contact, in particular a power bus having a planar first contact surface, a step for providing a second planar terminal contact having a second contact surface, a step for embossing a structure into the first planar terminal contact, whereby an edge of the first planar terminal contact is pressed out of the plane of the planar first contact surface by embossing the structure, a step for arranging the first contact surface of the first planar terminal contact on the second contact surface of the second planar terminal contact, and a step for fixing the first planar terminal contact to the second planar terminal contact by means of a connecting element, whereby the first contact surface of the first planar terminal contact is pressed against the second contact surface of the second planar terminal contact and the edge of the first planar terminal contact is pressed into the second contact surface of the second planar terminal contact. In this way, a connection arrangement with advantageously low electrical contact resistance can be made between the planar terminal contacts in a simple and inexpensive manner. The foreign layers on the two planar terminal contacts are broken up at the contact locations, and a stable contact with low electrical contact resistance is created between the two planar terminal contacts.

According to one advantageous exemplary embodiment, it is provided that a first recess is formed in the first planar terminal contact, whereby the side of the first planar terminal contact forms the edge around the first recess, whereby the connecting element, in particular a screw connection, is inserted through the first recess when fixing the first planar terminal contact to the second planar terminal contact. A mechanically stable connection with a low electrical contact resistance is thus established in a straightforward manner.

According to an advantageous exemplary embodiment, it is provided that a funnel-shaped structure is embossed around the first recess, whereby the edge is pressed out of the plane of the first contact surface in an annular manner. Such a structure is particularly suitable when a screw head presses the first planar terminal contact against the second planar terminal contact. When the connection is tightened, the structure is pressed evenly flat, and the edge moves in a radial direction away from the connecting element, for example in the form of a screw, over the second contact surface and breaks up the foreign layer on the second contact surface around the connecting element in an annular manner.

According to one advantageous exemplary embodiment, it is provided that, when the first planar terminal contact is fixed to the second planar terminal contact, the edge is pressed into the second contact surface of the second planar terminal contact in an annular manner, in particular surrounding a second recess in the second planar flat terminal contact. An advantageous contact with low electrical contact resistance is thus provided.

### BRIEF DESCRIPTION OF THE DRAWINGS

One exemplary embodiment of the invention is shown in the drawings and explained in more detail in the following description. Shown are:

FIG. 1 an exemplary embodiment of a first planar terminal contact,

FIG. 2 a further view of the exemplary embodiment of the first planar terminal contact,

FIG. 3 a cross section through the exemplary embodiment of the first planar terminal contact,

FIG. 4 a cross section through an exemplary embodiment of the connection arrangement prior to fixing the first planar terminal contact to the second planar terminal contact,

FIG. 5 an enlarged cross-section through the exemplary embodiment of the connection arrangement when fixing the first planar terminal contact to the second planar terminal contact,

FIG. 6 a cross section through an exemplary embodiment of the connection arrangement after fixing the first planar terminal contact to the second planar terminal contact.

### DETAILED DESCRIPTION

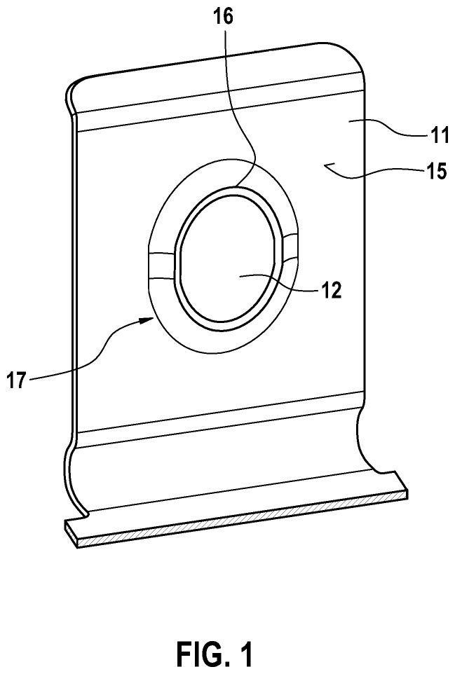

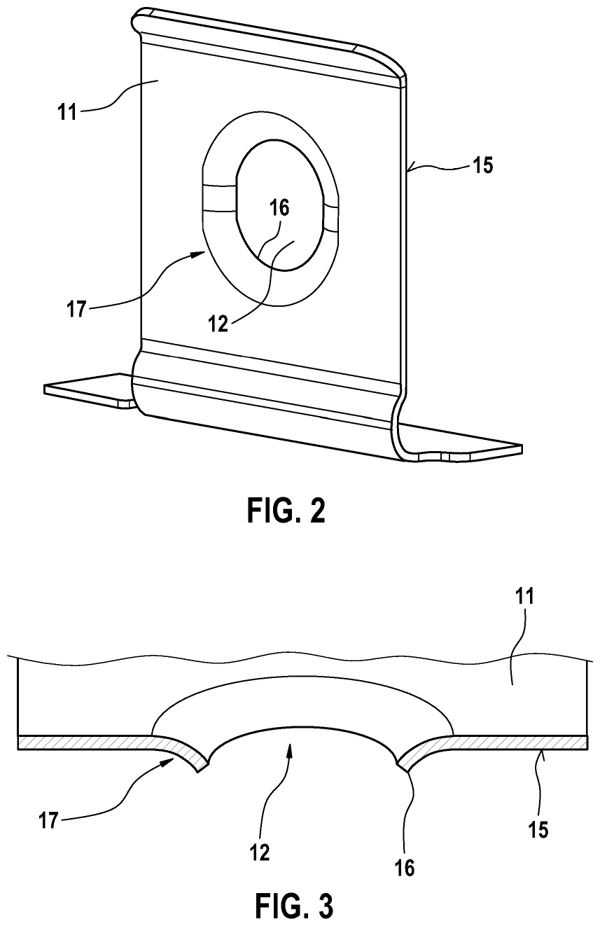

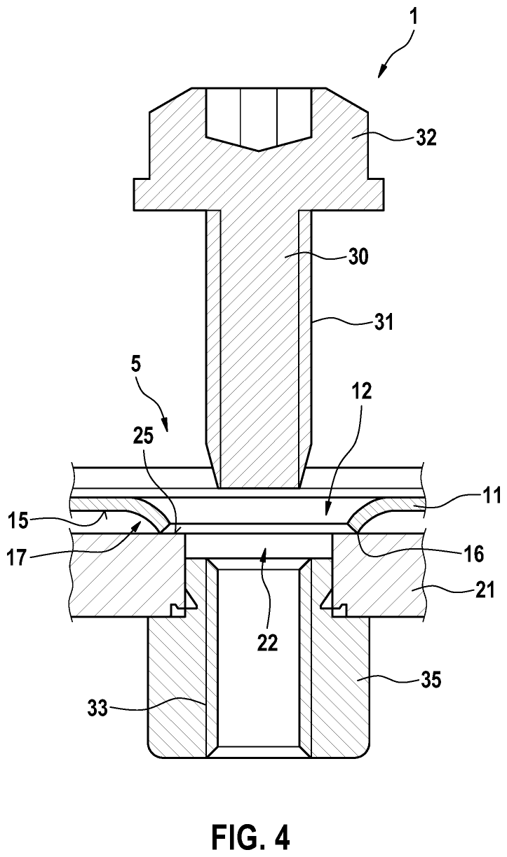

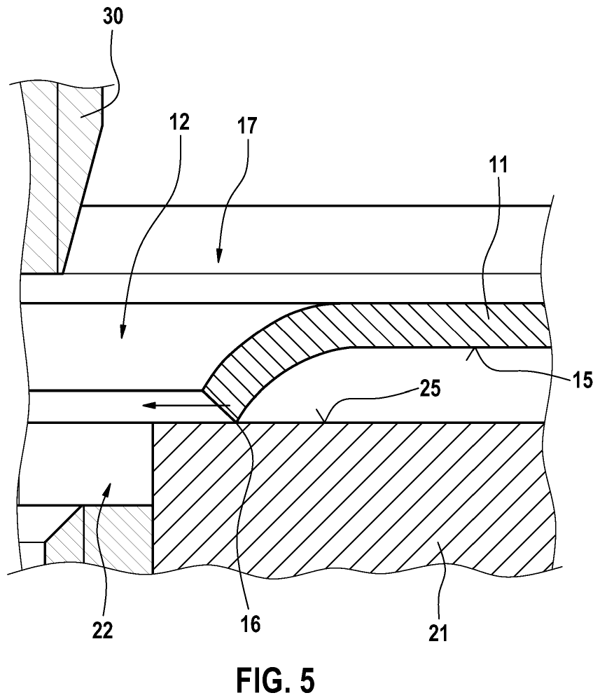

FIGS. 1 to FIG. 3 show various views of one exemplary embodiment of a first planar terminal contact 11. FIG. 4 to FIG. 5 show an exemplary embodiment of the connection arrangement 1 with the exemplary embodiment of the first planar terminal contact 11 in FIG. 1 to FIG. 3. The connection arrangement 1 can be used in all applications in which high currents must be conducted via contact connections and power losses must be kept low. For example, the connection arrangement 1 can be used in systems that carry high currents, for example in power electronics, for example in electric vehicles or hybrid vehicles. For example, the connection arrangement 1 can be used in power electronics, for transducers or batteries.

The connection arrangement 1 comprises a first planar terminal contact 11 which can, e.g., be an electrical terminal of a first electrical and/or electronic component. The connection arrangement 1 further comprises a second planar terminal contact 21 which can, e.g., be an electrical connector of a second electrical and/or electronic component. The electrical and/or electronic components can be or can include, for example, inverters, converters, DC/DC converters, capacitors, for example DC-link capacitors, batteries, or, for example, other electronic and/or electric components used in electric vehicles or hybrid vehicles.

The first electrical and/or electronic component is connected to the second electrical and/or electronic component in an electrically conductive manner. The electrically conductive connection between the first electrical and/or electronic component and the second electrical and/or electronic component is established via the planar terminal contacts 11, 21. For this purpose, the first planar terminal contact 11 is electrically connected to the second planar terminal contact 21. For this purpose, the first planar terminal contact 11 rests flat, in particular directly, on the second planar terminal contact 21.

The planar terminal contacts 11, 21 are made of an electrically conductive material, e.g. a metal such as copper. Copper has an advantageously low material resistance. The first planar terminal contact 11 can be made of the same material as the second planar terminal contact 21. However, the first planar terminal contact 11 and the second planar terminal contact 21 can also be made of different materials. The planar terminal contacts 11, 21 are designed to be substantially planar, at least in the region where they overlap. The planar terminal contacts 11, 21 comprise planar contact surfaces 12, 22 in the overlap region 5 where the planar terminal contacts 11, 21 adjoin one another, so that an electrically conductive connection is established between the planar terminal contacts 11, 21. The planar terminal contacts 11, 21 are arranged to be coplanar with one another with respect to their planar extension planes. In the exemplary embodiment shown, the planar terminal contacts 11, 21 are designed as power buses 11, 21. In the context of the present application, a power bus 11, 21 is understood to mean an electrically conductive planar conductor, for example an electrically conductive bar or strip. A power bus can thus be a busbar, for example. The power buses 11, 21 can, e.g., be bent, curved, or can also extend in a curved or incremental fashion. The power buses 11, 21 are made of an electrically conductive material, e.g. a metal such as copper. The power buses 11, 21 are, e.g., designed to be integral. The power buses 11.21 are, e.g., entirely made of the same material. The power buses 11, 21 are, e.g., designed as stamped parts. For example, each of the power buses 11, 21 has a thickness of the power buses 11, 21 that is constant over a longitudinal extension of the power buses 11, 21, for example perpendicular to the current direction. For example, each of the power buses 11, 21 can have a thickness of the power buses 11, 21 that is constant over a longitudinal extension of the power buses 11, 21, for example perpendicular to the current direction. A first recess 12 is formed in the first planar terminal contact 11. A second recess 22 is formed in a second planar terminal contact 21. The first recess 12 in the first planar terminal contact 11 has, e.g., a greater surface area than the second recess 22 in the second planar terminal contact 21.

The recesses 12, 22 are used to receive a connecting element 30 for the mechanical connection of the planar terminal contacts 11, 21 to each other. The connecting element 30 is inserted through the recesses 12.22. The connecting element 30 is tightened and thus presses the contact surfaces 12, 22 of the planar terminal contacts 11, 21 against each other. The connection element 30 establishes a mechanical connection between the first planar terminal contact 11 and the second planar terminal contact 21. The connecting element 30 can, e.g., be designed as a screw 31. The screw 31 passes through the terminal contacts 11, 21 in the overlap region 5 where the terminal contacts 11, 21 overlap. For this purpose, a first recess 12 is formed in the first planar terminal contact 11, and a second recess 22 is formed in the second planar terminal contact 21. The screw 31 projects through the first recess 12 of the first planar terminal contact 11 and through the second recess 22 of the second planar terminal contact 21. In the recesses 12, 22, the screw 31 is at a distance from the first planar terminal contact 11, from the second planar terminal contact 21, and does not contact them. A screw head 32 is formed at a first end of the screw 31. At the second end of the screw 31 facing away from the first end of the screw 31, the screw 31 is screwed into a counter-thread 33. The counter-thread 33 is formed in another component 35, for example a screw socket, a screw nut, or a housing. The screw head 32 covers the first recess 12 in the first planar terminal contact 11 and thus applies a force on the first planar terminal contact 11 when the screw 31 is screwed into the counter-thread 33, which presses the first contact surface 15 of the first planar terminal contact 11 against the second contact surface 25 of the second planar terminal contact 21. The screw head 32 has, e.g., a larger diameter than the first recess 12. The first contact surface 15 of the first planar terminal contact 11 is thus pressed by the screw 31 to the contact surface 25 of the second planar terminal contact 21. The two planar terminal contacts 11, 21 are arranged between the screw head and the counter-thread 33. The connection element 30 can, e.g., be made of a metal, for example steel.

FIG. 1 to FIG. 3 show one exemplary embodiment of the first planar terminal contact 11. The first planar terminal contact 11 in this exemplary embodiment is designed as a power bus, also called a busbar. The first planar terminal contact 11 is made of an electrically conductive material, e.g. from a metal such as from copper. For example, the first electrical terminal contact 11 is punched, and/or bent, and/or embossed from a metal sheet. The first planar terminal contact 11 comprises a first contact surface 15. The first contact surface 15 is designed to be planar, and thus extends in one plane. In the first terminal contact 11, a first recess 12 is designed to receive a connecting element 30. In this embodiment, the first recess 12 is stamped into the first terminal contact 11. The first recess 12 can, e.g., be a hole for receiving a screw as the connecting element 30. Furthermore, a structure 17 is embossed around the first recess 12 in the first terminal contact 11. The structure 17 is designed to be funnel-shaped. Due to the funnel-shaped structure 17, the edge of the first terminal contact 11 around the first recess 12 is bent out of the plane of the first contact surface 15 and protrudes from it. As a result, an edge 16 is formed that presses into the second contact surface 22 when the first planar terminal contact 11 is fixed, in particular when it is screwed to the second flat terminal contact 21.

FIGS. 4 to 6 show how the electrically conductive and mechanical connection is made between the planar terminal contacts 11, 21 of the connection arrangement 1. FIG. 4 shows a cross section through an exemplary embodiment of the connection arrangement 1 prior to fixing the first planar terminal contact 11 to the second planar terminal contact 21.

FIG. 5 shows an enlarged cross-section through the exemplary embodiment of the connection arrangement 1 when fixing the first planar terminal contact 11 to the second planar terminal contact 21. When the screw 31 is tightened, the edge 16 of the first planar terminal contact 11 makes pointed contact with the second contact surface 25 of the second planar terminal contact 21. The edge 16 faces towards the second contact surface 25. If the screw 31 is tightened further, the structure 17 embossed in the first planar terminal contact 11 is pressed flat and the edge 17 breaks through the foreign layer, for example the oxide layer, on the second contact surface 25. The arrow shows the direction of movement of the edge 17 on the second contact surface 25 when the screw is tightened and the structure 17 is pressed flat.

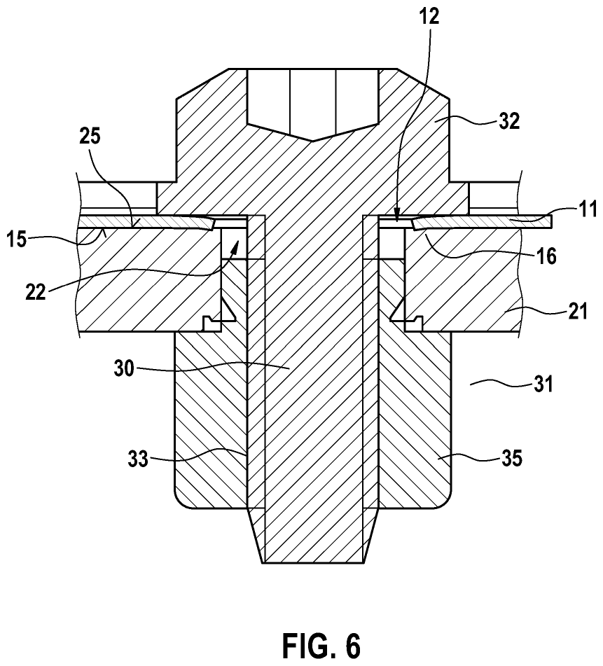

FIG. 6 shows a cross section through the exemplary embodiment of the connection arrangement 1 after fixing the first planar terminal contact 11 to the second planar terminal contact 21. After tightening the screw, the relative movement of the edge 17 on the second contact surface 25 breaks up the foreign layers which can, e.g., be oxide layers on the two planar terminal contacts 11, 21 in the area of the edge 16. The edge 16 is pressed into the second contact surface 25. The structure 17 is largely or entirely pressed flat by the force of the screw connection, in particular in the area below the screw head 32.

Of course, further exemplary embodiments and mixed forms of the illustrated exemplary embodiment are also possible.

1. A connection arrangement (1) comprising: a first planar terminal contact (11) having a planar first contact surface (15) for electrically contacting a first electrical and/or electronic component; and a second planar terminal contact (21) having a second contact surface (25) for electrically contacting a second electrical and/or electronic component, wherein the first planar terminal contact (11) and the second planar terminal contact (21) overlap in an overlap region (5), wherein the first contact surface (15) faces the second contact surface (25), wherein the first planar terminal contact (11) and the second planar terminal contact (21) are connected by a connecting element (30), and the first contact surface (15) is pressed against the second contact surface (25) by the connecting element (30),
wherein a structure (17) is embossed into the first planar terminal contact (11) so that an edge (16) of the first planar terminal contact (11) projects out of a plane of the first contact surface (15), wherein the edge (16) projecting from the plane of the first contact surface (15) is pressed into the second contact surface (25) of the second planar terminal contact (21) by the connecting element (30).

2. The connection arrangement according to claim 1, wherein a first recess (12) is formed in the first terminal contact (11) in the overlap region (5), wherein the edge (16) is formed by a side of the first terminal contact (11) around the first recess (12), wherein the connecting element (30) extends through the first recess (12) in the first planar terminal contact (11).

3. The connection arrangement according to claim 2, wherein a funnel-shaped structure (17) embossed around the first recess (12) is formed in the first terminal contact (11).

4. The connection arrangement according to claim 1, wherein the connecting element (30) is a screw (31), and the first planar terminal contact (11) and the second planar terminal contact (21) are connected to each other and pressed together by the screw (31).

5. The connection arrangement according to claim 2, wherein a second recess (22) is formed in the second planar terminal contact (21), through which the connecting element (30) projects, wherein the edge (16) is pressed around the second recess (22), and the edge (16) is pressed circumferentially into the second contact surface (25).

6. The connection arrangement according to claim 1, wherein the first planar terminal contact (11) is configured as a power bus, and/or the second planar terminal contact (21) is configured as a power bus.

7. A method for manufacturing a connection arrangement comprising the following steps:
providing a first planar terminal contact (11) having a planar first contact surface (15),
providing a second planar terminal contact (21) having a second contact surface (25),
embossing a structure (17) into the first planar terminal contact (11), wherein an edge (16) of the first planar terminal contact (11) is pressed out of a plane of the planar first contact surface (15) by embossing the structure (17),
arranging the first contact surface (15) of the first planar terminal contact (11) on the second contact surface (25) of the second planar terminal contact (21), and
fixing the first planar terminal contact (11) to the second planar terminal contact (21) by a connecting element (30), wherein the first contact surface (15) of the first planar terminal contact (11) is pressed against the second contact surface (25) of the second planar terminal contact (21), and the edge (16) of the first planar terminal contact (11) is pressed into the second contact surface (25) of the second planar terminal contact (21).

8. The method according to claim 7, wherein a first recess (12) is formed in the first planar terminal contact (11), wherein a side of the first planar terminal contact (11) forms the edge (16) around the first recess (12), wherein the connecting element (30) is inserted through the first recess (12) when the first planar terminal contact (11) is fixed to the second planar terminal contact (21).

9. The method according to claim 8, wherein a funnel-shaped structure (17) is embossed around the first recess (12), wherein the edge (16) is pressed out of the plane of the first contact surface (15) in an annular manner.

10. The method according to claim 8, wherein when fixing the first planar terminal contact (11) to the second planar terminal contact (21), the edge (16) is pressed in an annular manner into the second contact surface (25) of the second planar terminal contact (21).

11. The connection arrangement according to claim 1, wherein the connection arrangement is for use in electric vehicles or hybrid vehicles.

12. The connection arrangement according to claim 5, wherein the edge (16) is pressed annularly around the second recess.

13. The method according to claim 7, wherein the first planar terminal contact (11) is a power bus.

14. The method according to claim 8, wherein the connecting element (30) is a screw (31).

15. The method according to claim 10, wherein the edge (16) surrounds a second recess (22) in the second planar terminal contact (21).
